(19) United States
(12) Patent Application Publication
(10) Pub. No.: US 2021/0237288 A1
(43) Pub. Date: Aug. 5, 2021

(54) KNIFE WITH AN INTEGRAL ANGLE-ASSIST JIG PORTION

(71) Applicant: Steven R. Godfrey, Phoenix, AZ (US)

(72) Inventor: Steven R. Godfrey, Phoenix, AZ (US)

(21) Appl. No.: 17/164,386

(22) Filed: Feb. 1, 2021

Related U.S. Application Data
(60) Provisional application No. 62/968,150, filed on Jan. 31, 2020.

(51) Int. Cl. B26B 3/02; B24B 3/54

(52) U.S. Cl. CPC B26B 3/02; B24B 3/54

(57) ABSTRACT

Various embodiments for a knife having a bolster angle assist bevel that eliminates the need for an external jig are disclosed herein. The knife includes a blade extending from a bolster in which the blade defines first and second blade ends with a spine that extends between the first blade end and the second blade end. The blade forms a primary bevel that transitions into a secondary bevel that forms a cutting edge. In addition, the bolster forms an integral bolster angle-assist jig portion having a flat, beveled angled surface configured for establishing a sharpening angle relative to a sharpening stone when sharpening the cutting edge of the blade.

### CROSS REFERENCE TO RELATED APPLICATIONS

This is a non-provisional application that claims benefit to U.S. provisional application Ser. No. 62/968,150 filed on Jan. 31, 2020, which is herein incorporated by reference in its entirety.

### FIELD

This present disclosure relates generally to knife sharpening and more specifically to a knife with an integral bolster angle-assist jig portion for sharpening a knife.

### BACKGROUND

The knife is one of humanity's oldest known tools and as such, many individuals require a sharp knife—from a chef in a kitchen to a soldier on a battlefield. One of the greatest challenges facing people who depend on a sharp knife is re-sharpening their knife once it becomes dull. For traditional knives, a key to obtaining a sharp knife edge lies in the user's skill in the art of maintaining a consistent angle while running a knife edge along a sharpening stone. Those who are skilled in this technique can sharpen a knife with just a few swipes on a sharpening stone. Knife sharpening, however, generally requires a skill that is not quickly mastered. This skill takes most people years to perfect. In the meantime, it is very easy to do damage to a knife's edge through improper sharpening.

To avoid improper sharpening, non-experts use a jig. For a knife including a primary bevel and a secondary bevel, a jig establishes the angle of a knife's secondary bevel for forming a sharp cutting edge. A jig helps the knife sharpener maintain a consistent angle when sharpening a knife blade. Unfortunately, these jigs are cumbersome and otherwise inconvenient to use.

Some knives, primarily but not limited to higher end culinary knives, have a bolster. Traditionally a chef knife bolster is a thick portion between the handle and the knife blade which provides a transition from the blade to the handle. A bolster may add durability, strength and assist as a counter-balance. A traditional bolster is thus an unsharpened portion of certain knives positioned between the blade and the handle.

The ability to sharpen a knife blade without requiring an external jig or strong expertise is a challenge for those that depend on a sharp knife. Although external jigs have been developed to assist the knife sharpener maintain a consistent angle when sharpening a blade. Unfortunately, these jigs can be cumbersome and otherwise inconvenient to use. External jigs must also be carried as extra equipment when traveling.

It is with these observations in mind, among others, that various aspects of the present disclosure were conceived and developed.

### BRIEF DESCRIPTION OF THE DRAWINGS

FIG. 1 shows a perspective view of a first embodiment of a knife having an integral bolster angle-assist jig portion.

FIG. 2 is a side view of the knife of FIG. 1.

FIG. 3 shows a bottom view of the knife of FIG. 1.

FIG. 4 shows an end view of the knife of FIG. 1.

FIG. 5 is an illustration showing the integral bolster angle assist jig portion of the knife of FIG. 1 in contact with a sharpening stone for establishing an angle for sharpening the secondary bevel as the blade of the knife is drawn across the sharpening stone at the established angle set by the bolster angle assist jig portion.

FIG. 6 is a side view of a second embodiment of a knife having an integral bolster angle assist jig portion.

FIG. 7 is a bottom view of the knife of FIG. 6.

FIG. 8 is an end view of the knife of FIG. 6.

FIG. 9 is an illustration showing the integral bolster angle assist jig portion of the knife of FIG. 6 in contact with a sharpening stone for establishing an angle for sharpening the secondary bevel as the blade of the knife is drawn across the sharpening stone at the established angle set by the bolster angle assist jig portion.

FIG. 10 is a side view of a third embodiment of a knife having an integral angle assist jig portion.

FIG. 11 is a bottom view of the knife of FIG. 10.

FIG. 12 is an end view of the knife of FIG. 10.

FIG. 13 is an illustration showing the integral bolster angle assist jig portion of the knife of FIG. 10 in contact with a sharpening stone for establishing an angle for sharpening the secondary bevel as the blade of the knife is drawn across the sharpening stone at the established angle set by the bolster angle assist jig portion.

FIG. 14 is an isolated cross-sectional view of the bolster having the integral dual angle assist jig portion of FIG. 1.

FIG. 15 is an isolated cross-sectional view of a bolster having an integral single angle-assist jig portion of FIG. 10.

FIGS. 16A-16D illustrate a method for using the bolster angle-assist jig portion of the knife along a sharpening stone.

Corresponding reference characters indicate corresponding elements among the view of the drawings. The headings used in the figures do not limit the scope of the claims.

### DESCRIPTION

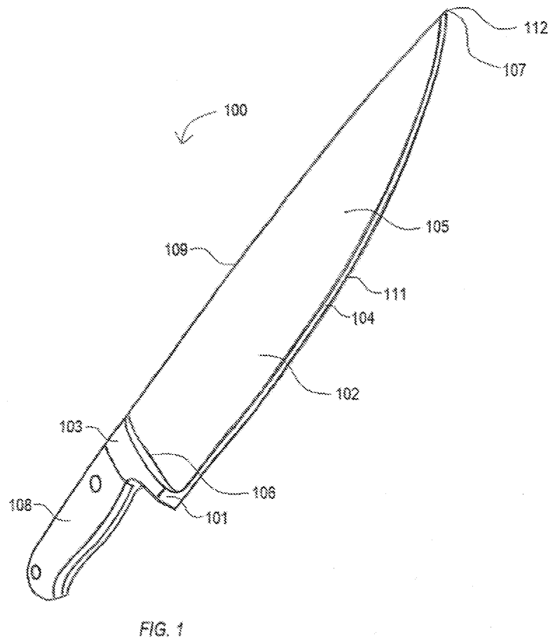

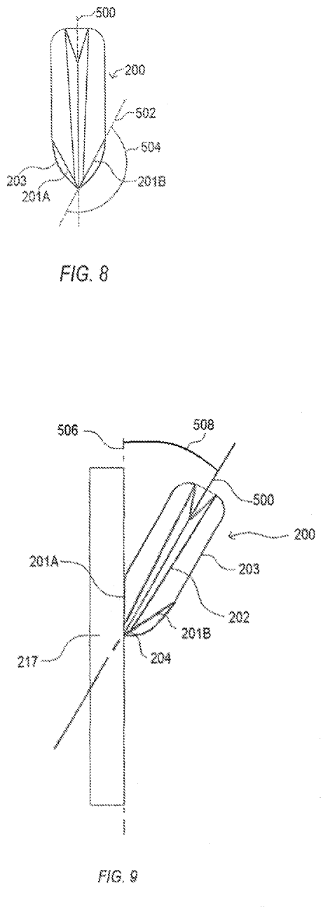

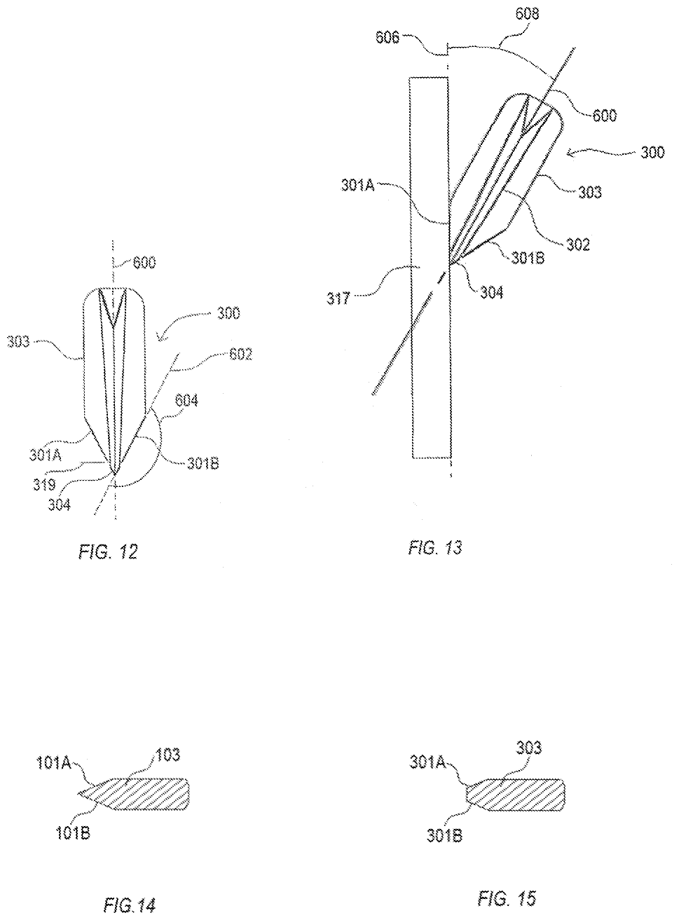

Various embodiments of systems and methods for sharpening a knife having an integral bolster angle-assist jig portion that reduces the time it takes for a user to develop an intuitive feel for establishing and maintaining an angle required for grinding the knife along a sharpening stone, thereby eliminating the need for an external jig when sharpening the knife are disclosed herein. In one aspect, the knife provides an integral angle-assist jig portion along the bolster of the knife that allows a user to establish and maintain the blade at the same angle along the sharpening stone when sharpening the blade of the knife. Referring to the drawings, embodiments of a knife with an integral bolster assist-angle jig portion are illustrated and generally indicated as 100, 200 and 300 in FIGS. 1-16.

Referring to FIGS. 1-5, a knife 100 includes an elongated blade 102 defining a spine 109 that extends from a first blade end 106 to a second blade end 107 defined by the blade 102. The knife 100 further includes a bolster 103 formed between the blade 102 and a handle 108. In addition, the blade 102 defines a primary bevel 105 that transitions into a secondary bevel 104 in which the secondary bevel 104 forms a cutting edge 111 along the blade 102. Reference to coupling or connection of components, unless specified otherwise, includes direct connection as well as connection through intervening components.

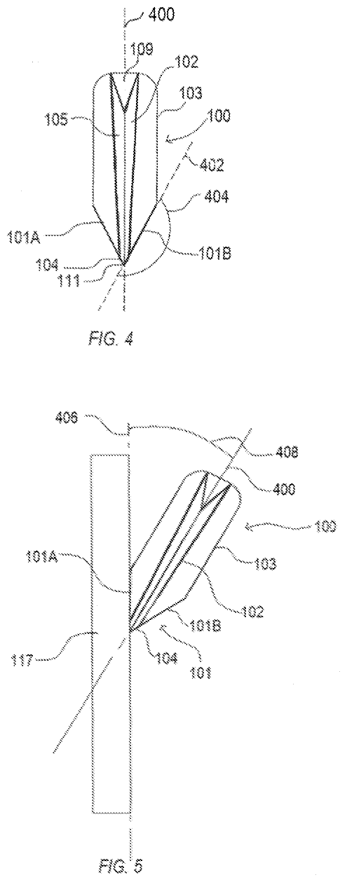

As shown, the bolster 103 defines an integral bolster angle-assist jig portion 101 that establishes a sharpening angle 408 (FIG. 5) to grind against the secondary bevel 104 of the blade 102 against a sharpening stone 117. The sharpening angle 408 is defined as the angle between the axis 400 that extends along the center line of the bolster 103 and axis 406 that extends along the surface of the sharpening stone 117.

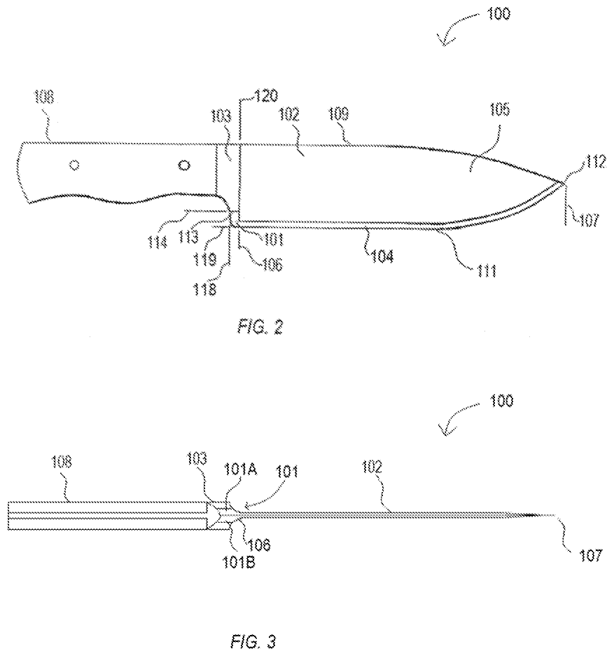

The bolster angle-assist jig portion 101 may be sharpened or unsharpened, but sharpening of the bolster angle-assist jig portion 101 is not necessary for its function as a jig for setting the sharpening angle 408 of the secondary bevel 104 of the blade 102 during the sharpening procedure. In this embodiment, the bolster angle-assist jig portion 101 is integrally formed along the bolster 103 directly adjacent the second blade end 106 of the blade 102 bounded by an axis 118 that extends longitudinally along the bolster 103, a latitudinal axis 119 that extends along the cutting edge 111, and an axis 120 that extends along the first blade end 106 as illustrated in FIG. 2. As such, the bolster angle-assist jig portion 101 forms a substantially rectangular or square-shaped area along the bolster 103 bounded by the first blade end 106 and secondary bevel 104 that provides an angular surface for establishing a sharpening angle 408 (FIG. 5) for the blade 102 as shall be discussed in greater detail below.

As shown in FIGS. 3 and 5, in some embodiments the bolster angle-assist jig portion 101 may define dual bolster angle-assist jig portions 101A and 101B formed along respective opposite sides of the bolster 103, although in other embodiments, a single bolster angle-assist jig portion 101 may be formed along only one side of the bolster 103 as might be illustrated by FIG. 2.

The method of using the integral jig portion 101 does not require an unreasonably large amount of skill and experience to master when used to establish and then maintain the sharpening angle 408 of the knife 100 along the sharpening stone 117. In one aspect, the integral angle-assist jig portion 101 of the knife 100 provides a user a convenient surface area for obtaining improved consistency in establishing and then maintaining the sharpening angle 408 (FIG. 5) of the secondary bevel 104 along the sharpening stone 117 as the cutting edge 111 is sharpened.

As shown in FIGS. 1 and 2, the blade 102 further defines a blade point 112 at the second blade end 107 of the blade 102 which defines an angle where the spine 109 and the cutting edge 111 of the secondary bevel 104 meet. In some embodiments, the blade point 112 may define a sharpened end.

As further shown, the spine 109 is defined between the first blade end 106 and the second blade end 107 while the cutting edge 111 is defined opposite the spine 109. The spine 109 extends along a side of the blade 102 opposite the cutting edge 111. In some embodiments, the spine 109 may be the thickest portion along the length of the blade 102 from the bolster 103 to the blade point 112. In some embodiments, the cutting edge 111 extends along one side of the blade 102 from the bolster 103 to the blade point 112 opposite the spine 109. In some embodiments, the cutting edge 111 may curve along the second blade end 107 adjacent the blade point 112.

In some embodiments, the primary bevel 105 may be flat, convexly or concavely ground. In some embodiments, the primary bevel 105 is flat. In other embodiments, the primary bevel 105 includes a concave and/or rounded transition point at the first distance from the spine 109. In some embodiments, the primary bevel 105 extends in the shape of a circular arc.

As noted above, the secondary bevel 104 is defined between the primary bevel 105 and the cutting edge 111 and extends parallel to the cutting edge 111 from the bolster 103 to the second blade end 107 before terminating at the cutting edge 111. In some embodiments, the secondary bevel 104 may be flat or concavely ground.

As shown in FIG. 2, the bolster angle-assist jig portion 101 defines an angle-assist bevel boundary line 113 extending along a second longitudinal axis 114 that provides a visual and/or tactile cue to the user for establishing contact between the bolster angle-assist jig portion 101 and the sharpening stone 117 at the sharpening angle 408. In some embodiments, the integral bolster angle-assist jig portion 101 of the knife 100 is formed along the bolster 103 adjacent the cutting edge 111 of the blade 102. In some embodiments, the bolster angle-assist jig portion 101 defines a flat area, concavely ground area and/or beveled surface area. In one aspect, the size, sharpness, and shape of the bolster 103 will not impede its function as an integral angle-assist jig as long as the area of the angle-assist jig portion 101 defined along the bolster 103 is configured to lie substantially flat against the sharpening stone 117 (FIG. 5) at the sharpening angle 408.

In some embodiments, the bolster angle assist jig portion 101 is formed at a same angle as the secondary bevel 104 which is the angle 404 defined between the longitudinal axis 400 along the centerline of the bolster 103 and the axis 402 defined along the surface of the bolster angle-assist jig portion 101 as illustrated in FIG. 4. The angle 404 defined by the bolster angle-assist jig portion 101 may be an angle between 7 degrees to 15 degrees; between 15 degrees to 30 degrees; between 5 degrees to about 50 degrees; between 5 degrees to 10 degrees; between 10 degrees to 20 degrees; between 20 degrees to 30 degrees; between 30 degrees to 40 degrees; between 40 degrees to 50 degrees; or between 7 degrees to 35 degrees.

In another embodiment, an example of knife 100 with the blade 102 having a pair of opposing bolster angle assist jig portions 101A and 101B (FIGS. 2 and 3). In some embodiments, one respective side of the primary bevel 105, the secondary bevel 104, and the bolster angle assist jig portion 101 forms a flat surface or concavely ground, while the respective opposite side of the primary bevel 105, the secondary bevel 104, and the bolster angle assist jig portion 101 may be flat or concavely ground.

FIG. 5 depicts the knife 100 of FIGS. 1-4 being used with a sharpening stone 117. In this arrangement, the bolster angle assist jig portion 101 functions as an improved, integrated sharpening jig. In one method of use, one side of the bolster 103, for example bolster angle assist jig portion 101A, is used to establish the sharpening angle 408 between the blade 102 and the sharpening stone 217, thereby making it easier for a user to hold the knife 100 against a sharpening stone 117 at the desired sharpening angle 408 across the secondary bevel 104. In particular, a user places the sharpening stone 117 against a bolster angle assist jig portion 101 to achieve the desired angle 406 between the longitudinal axis 406 of the sharpening stone 117 and longitudinal axis 400 of the bolster 103 for sharpening the blade 102 against the sharpening stone 117 at the correct angle. The user maintains the blade 102 at the same angle 408 achieved with the bolster angle assist jig portion 101A when moving the blade 102 in a direction across the sharpening stone 117 from the bolster 103 toward the blade point 112.

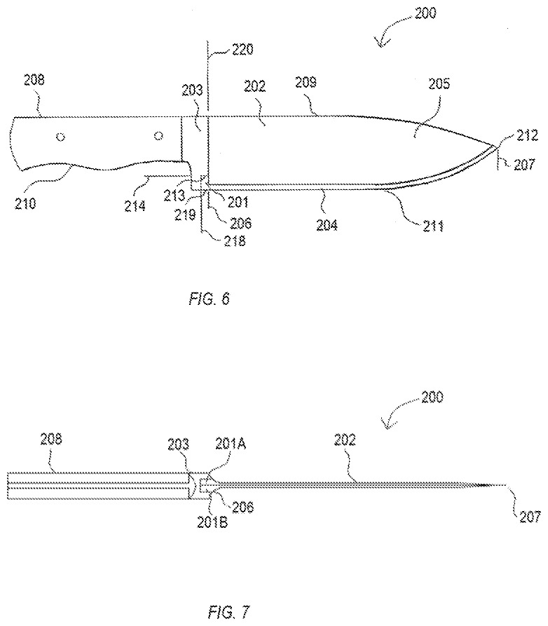

Referring to FIGS. 6-9, a second embodiment of the knife, designated 200, is illustrated. The knife 200 includes a blade 202 defining a spine 209 that extends from a first blade end 206 to a second blade end 207. The knife 200 further includes a bolster 203 formed between the blade 202 and a handle 208. In addition, the blade 202 defines a primary bevel 205 that transitions into a secondary bevel 204 in which the secondary bevel 204 forms a cutting edge 211 of the blade 202. Reference to coupling or connection of components, unless specified otherwise, includes direct connection as well as connection through intervening components.

As shown, the bolster 203 defines an integral bolster angle-assist jig portion 201 that establishes a sharpening angle 508 (FIG. 9) to grind the secondary bevel 204 against a sharpening stone 217. The sharpening angle 508 is defined as the angle between the axis 500 that extends along the center line of the bolster 203 and axis 506 that extends along the surface of the sharpening stone 217. The bolster angle-assist jig portion 201 may be sharpened or unsharpened, but sharpening of the bolster angle-assist jig portion 201 is not necessary for its function as a jig for setting the sharpening angle 508 for the secondary bevel 204 of the blade 202 during a sharpening procedure. In this embodiment, the bolster angle-assist jig portion 201 is integrally formed along the bolster 203 directly adjacent the second blade end 206 bounded by an axis 218 that extends longitudinally along the middle of the bolster 203, latitudinal axis 219 that extends along the cutting edge 211 of the secondary bevel 204, longitudinal axis 220 that extends along the first blade end 206, and latitudinal axis 213 that defines a boundary line along the bolster 203 as illustrated in FIG. 6.

In some embodiments, as shown in FIG. 7 the bolster angle-assist jig portion 201 may define dual bolster angle-assist jig portions 201A and 201B formed along respective opposite sides of the bolster 203, although in other embodiments, a single bolster angle-assist jig portion 201 may be formed along only one side of the bolster 203 as might be illustrated by FIG. 6.

As noted with the other embodiment, the method of using the integral jig portion 201 of the knife 200 does not require an unreasonably large amount of skill and experience to master when used to establish and then maintain the sharpening angle 508 of the knife 200 along the sharpening stone 217. In one aspect, the integral angle-assist jig portion 201 of the knife 200 provides a user a convenient surface area for obtaining improved consistency in establishing and maintaining the sharpening angle 508 (FIG. 9) of the secondary bevel 204 along the sharpening stone 217 while sharpening the cutting edge 211.

Referring to FIGS. 6 and 7, similar to the blade 102, blade 202 also defines a blade point 212 at the second blade end 207 of the blade 202 that defines an angle where the spine 209 and the cutting edge 211 of the blade 202 meet. The connection between the spine 209 and the cutting edge 211 at the blade point 212 may be a direct connection, or alternatively, a connection may include one or more intervening components.

As shown, the spine 209 is defined between the first blade end 206 and the second blade end 207 and the cutting edge 211 defined opposite the spine 109. The spine 209 extends along a side of the blade 202 opposite the cutting edge 211. In some embodiments, the spine 209 may be the thickest portion along the length of the blade 202 from the bolster 203 to the blade point 212. As further shown, the cutting edge 211 extends along one side of the blade 202 from the bolster 203 to the blade point 212 opposite the spine 209. In some embodiments, the cutting edge 211 may curve along the second blade end 207 adjacent the blade point 212.

In some embodiments, the primary bevel 205 may be flat, convexly or concavely ground. In some embodiments, the primary bevel 205 is flat. In other embodiments, the primary bevel 205 includes a concave and/or rounded transition point at the first distance from the spine 209. In some embodiments, the primary bevel 205 extends in the shape of a circular arc.

As noted above, the secondary bevel 204 is defined between the primary bevel 205 and the cutting edge 211 and extends parallel to the cutting edge 211 from the bolster 203 to the second blade end 207 before terminating at the cutting edge 211. In some embodiments, the secondary bevel 204 may be flat or concavely ground.

Referring to FIG. 6, as noted above the bolster angle-assist jig portion 201 defines an angle-assist bevel boundary line 213 extending along a second longitudinal axis 214 that provides a visual and tactile cue for establishing the sharpening angle 508 between the bolster angle-assist jig portion 201 and the sharpening stone 217. In some embodiments, the bolster angle-assist jig portion 201 defines a flat area, a concavely ground area and/or a beveled surface area. In one aspect, the size, sharpness, and shape of the bolster 203 will not impede its function as an integral angle-assist jig as long as the area of the angle-assist jig portion 201 is configured to lie substantially flat against the sharpening stone 217 (FIG. 9).

FIG. 9 depicts the knife 200 of FIGS. 6-8 being used with a sharpening stone 217 similar to sharpening stone 117 of FIG. 5. In this arrangement, the bolster angle assist jig portion 201 functions as an improved, integrated sharpening jig. In one method of use, one side of the bolster 203, for example bolster angle assist jig portion 201A, is configured to establish a sharpening angle 508 between the blade 202 and the sharpening stone 217, thereby making it easier for a user to hold the knife 200 against a sharpening stone 217 at the desired sharpening angle 508 across the secondary bevel 204. In particular, a user places the sharpening stone 217 against a bolster angle assist jig portion 201 to achieve the sharpening angle 508 between the longitudinal axis 506 of the sharpening stone 217 and longitudinal axis 500 of the bolster 203 for sharpening the blade 202 against the sharpening stone 217 at the correct orientation. The user maintains the sharpening angle 508 achieved with the bolster angle assist jig portion 201A across the sharpening stone 217 while moving the blade 202 in a direction from the bolster 203 toward the blade point 212.

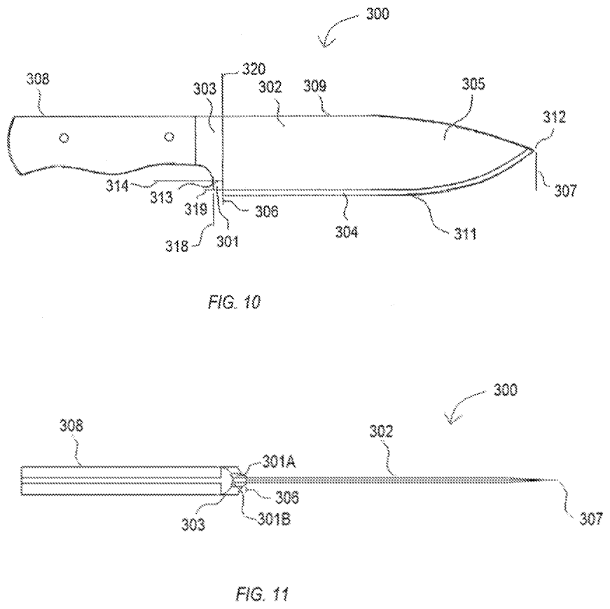

Referring to FIGS. 10-13, a third embodiment of the knife, designated 300, is illustrated. The knife 300 includes a blade 302 defining a spine 309 that extends from a first blade end 306 to a second blade end 307. The knife 300 further includes a bolster 303 formed between the blade 302 and a handle 308. In addition, the blade 302 defines a primary bevel 305 that transitions into a secondary bevel 304 in which the secondary bevel 304 forms a cutting edge 311 of the blade 302. Reference to coupling or connection of components, unless specified otherwise, includes direct connection as well as connection through intervening components.

As shown, the bolster 303 defines an integral bolster angle-assist jig portion 301 that establishes a sharpening angle 608 (FIG. 13) to grind the secondary bevel 304 against a sharpening stone 317 similar or identical to sharpening stones 117 and 217. The sharpening angle 608 is defined as the angle between the axis 600 that extends along the center line of the bolster 303 and axis 606 that extends along the surface of the sharpening stone 317. In this particular embodiment, the bolster angle-assist jig portion 301 is integrally formed along the entire side of the bolster 303 bounded by an axis 318 that extends longitudinally along the side edge of the bolster 303, a latitudinal axis 319 that extends along the bottom edge of the bolster 303 in parallel relation to the cutting edge 311, and longitudinal axis 320 that extends along the first blade end 306 of the blade 302 as illustrated in FIG. 10.

In some embodiments, as shown in FIG. 11 the bolster angle-assist jig portion 301 may define dual bolster angle-assist jig portions 301A and 301B formed along respective opposite sides of the bolster 303, although in other embodiments, a single bolster angle-assist jig portion 301 may be formed along only one side of the bolster 303 as might be illustrated by FIG. 10.

As noted with the other embodiments, the method of using the integral jig portion 301 of the knife 300 does not require an unreasonably large amount of skill and experience to master when used to establish and then maintain the sharpening angle 608 of the knife 300 along the sharpening stone 317. In one aspect, the integral angle-assist jig portion 301 of the knife 300 provides a user a convenient means for obtaining improved consistency in establishing and maintaining the angle 608 (FIG. 13) of the secondary bevel 304 along the sharpening stone 317 while sharpening the cutting edge 311.

Referring to FIGS. 10 and 11, similar to the blades 102 and 202, blade 302 also defines a blade point 312 at the second blade end 307 of the blade 302 that defines an angle where the spine 309 and the cutting edge 311 of the blade 302 meet. The connection between the spine 309 and the cutting edge 311 at the blade point 312 may be a direct connection, or alternatively, a connection may include one or more intervening components.

As shown, the spine 309 is defined between the first blade end 306 and the second blade end 307 and the cutting edge 231 defined opposite the spine 309. The spine 309 extends along a side of the blade 302 opposite the cutting edge 311. In some embodiments, the spine 309 may be the thickest portion along the length of the blade 302 from the bolster 303 to the blade point 312. As further shown, the cutting edge 311 extends along one side of the blade 302 from the bolster 303 to the blade point 312 opposite the spine 309. In some embodiments, the cutting edge 311 may curve along the second blade end 307 adjacent the blade point 312.

In some embodiments, the primary bevel 305 may be flat, convexly or concavely ground. In some embodiments, the primary bevel 305 is flat. In other embodiments, the primary bevel 305 includes a concave and/or rounded transition point at the first distance from the spine 309. In some embodiments, the primary bevel 305 extends in the shape of a circular arc.

As noted above, the secondary bevel 304 is defined between the primary bevel 305 and the cutting edge 311 and extends parallel to the cutting edge 311 from the bolster 303 to the second blade end 307 before terminating at the cutting edge 311. In some embodiments, the secondary bevel 304 may be flat or concavely ground.

Referring back to FIG. 10, a noted above the bolster angle-assist jig portion 301 defines an angle-assist bevel boundary line 313 extending along a second longitudinal axis 314 that provides a visual and tactile cue for establishing contact between the bolster angle-assist jig portion 301 and the sharpening stone 317. In some embodiments, as shown in FIG. 11 the integral bolster angle-assist jig portion 301 of the knife 300 is formed along the bolster 303 adjacent the cutting edge 311 of the blade 302. In some embodiments, the bolster angle-assist jig portion 301 defines a flat area, concavely ground area and/or beveled surface area. In one aspect, the size, sharpness, and shape of the bolster 303 will not impede its function as an integral angle-assist jig as long as the area of the angle-assist jig portion 301 is configured to lie substantially flat against the sharpening stone 317 (FIG. 13).

FIG. 13 depicts the knife 300 of FIGS. 10-12 being used with a sharpening stone 317 similar to sharpening stones 117 and 217. In this arrangement, the bolster angle assist jig portion 301 functions as an improved, integrated knife sharpening jig. In one method of use, one side of the bolster 303, for example bolster angle assist jig portion 301A, is configured to establish the sharpening angle 608 of the blade 302, thereby making it easier for a user to maintain the knife 300 against a sharpening stone 317 at the desired angle 608 across the secondary bevel 304. In particular, a user places the sharpening stone 317 against a bolster angle assist jig portion 301 to achieve the desired angle 608 between the longitudinal axis 606 of the sharpening stone 317 and longitudinal axis 600 of the bolster 303 for sharpening the blade 302 against the sharpening stone 317 at the correct orientation. The user maintains the sharpening angle 608 achieved with the bolster angle assist jig portion 301A while moving the blade 302 in a direction from the bolster 303 toward the blade point 312 across at least a portion of the sharpening stone 317.

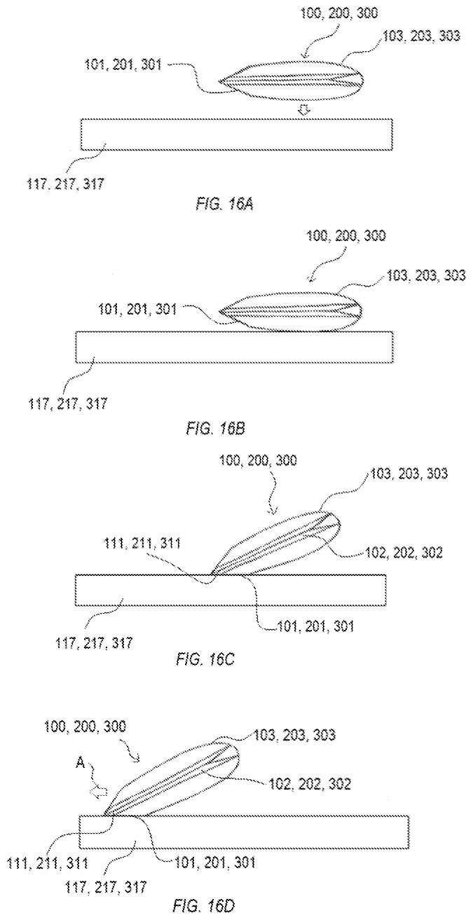

Referring to FIGS. 16A-16B illustrate a sequence of using a respective bolster angle-assist jig portion 101, 201, 301 against a respective sharpening stone 117, 217, 317 during the sharpening process. The bolster angle-assist jig portion 101, 201, 301 is brought into the contact with the sharpening stone 117, 217, 317 (FIGS. 16A and 16B). The bolster 103, 203, 303 is then oriented such that the bolster angle-assist jig portion 101, 201, 301 is in contact and flush with the surface of the sharpening stone 117, 217, 317 (FIG. 16C) before the bolster 103, 203, 303 is moved across the surface of the sharpening stone 117, 217, 317 along direction A (FIG. 16D) for sharpening the blade 100, 200, 300.

FIG. 14 illustrates a cross-sectional view of the bolster 103 showing the configuration of a dual bolster angle-assist jig portion 101 defining a pair of bolster angle-assist portions 101A and 101B. FIG. 15 illustrates a cross-sectional view of the bolster 303 showing the configuration of a dual bolster angle-assist portion 301 defining a pair of bolster angle-assist portions 301A and 301B.

The disclosed embodiments of the knives 100, 200, and 300 may be appropriate and suitable for a wide range of knives with a bolster such as, for example, a bread knife, a boning knife, a butcher knife, a chef knife, a cleaver, a paring knife, a hunting knife, a slicing knife, a utility knife, a folding knife, a breaking knife, a cheese knife, a table knife, a steak knife, a cimeter knife, a flank knife, a shoulder knife, a scalpel, a survival knife, an outdoorsperson knife, a gyuto knife, a meat carving knife, a nakiri knife, an oyster knife, a fishing knife, a military knife, a petty knife, a santoku knife, a sashimi knife, a hunting knife, a forged knife, or a stamped knife.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A knife, comprising:
a blade having a first blade end and a second blade end;
a blade point defined at the second blade end;
a spine extending between the first blade end and the second blade end;
a primary bevel formed along the blade that transitions into a secondary bevel forming a cutting edge, the secondary bevel defining a first angle; and
a bolster formed adjacent the first blade end of the blade, the bolster comprising:
a bolster angle-assist jig portion formed along the bolster, the bolster angle-assist jig portion comprising a beveled surface defining a second angle, wherein the first angle of the secondary bevel is equal to the second angle of the beveled surface.

2. The knife of claim 1, wherein the beveled surface of the bolster angle-assist jig portion terminates along a boundary line formed along the bolster.

3. The knife of claim 1, wherein the bolster angle-assist jig portion defines a flat, angled surface, a concavely angled surface and/or a beveled angled surface.

4. The knife of claim 1, further comprising a handle adjacent to the bolster.

5. The knife of claim 1, wherein the length of the bolster angle-assist jig portion extending from the bolster angle assist latitudinal start line toward the first blade end is about one-eighth of an inch to about 1 inch.

6. The knife of claim 1, wherein the beveled surface of the bolster angle-assist jig portion defines an angle of about 5 degrees to about 50 degrees.

7. The knife of claim 1, further comprising a second bolster angle-assist jig portion defined opposite the bolster angle-assist jig portion.

8. A method for sharpening a knife, comprising:
providing a knife comprising:
a blade having a first blade end and a second blade end;
a blade point defined at the second blade end;
a spine extending between the first blade end and the second blade end;
a primary bevel formed along the blade transitions into a secondary bevel that forms a cutting edge that extends between the first blade end and the second blade end, the secondary bevel defining a first angle relative to the angle of the spine; and
a bolster formed adjacent the first blade end of the blade, the bolster comprising:
a bolster angle-assist jig portion formed along the bolster, the bolster angle-assist jig portion comprising a beveled surface defining a second angle, wherein the first angle of the secondary bevel is equal to the second angle of the beveled surface;
contacting the beveled surface of the bolster angle-assist jig portion against a sharpening stone at the second angle defined by the beveled surface; and
grinding the cutting edge of the blade across the sharpening stone at the second angle established by the beveled surface of the bolster angle-assist jig portion.
